(19) United States
(12) Patent Application Publication
(10) Pub. No.: US 2009/0031195 A1
(43) Pub. Date: Jan. 29, 2009

(54) Method and apparatus for encoding and decoding Reed-Muller codes

(75) Inventor: Francis Tiong, Fremont, CA (US)

Correspondence Address: CARR & FERRELL LLP, 2200 GENG ROAD, PALO ALTO, CA, 94303, US

(73) Assignee: Digital Prospect Sdn.Bhd.

(21) Appl. No.: 11/881,189

(22) Filed: Jul. 25, 2007

(51) Int. Cl. G06F 11/07

(52) U.S. Cl. 714/781; 714/E11.023

(57) ABSTRACT

A method and apparatus for encoding and decoding Reed-Muller codes are provided. In exemplary embodiments, a method comprises receiving a code-word encoded with a Reed-Muller code, generating a pattern to retrieve voting bits, decoding the code-word based on the voting bits and, and providing the decoded code-word.

### BACKGROUND OF THE INVENTION

1. Field of Invention

Embodiments of the present invention are related to signal processing, and more particularly, to encoding and decoding code-words within signal processing using Reed-Muller codes.

2. Related Art

The use of Reed-Muller codes for error correction has become ubiquitous. For example, Reed-Muller codes have been applied to United States' Mariner-class deep space probes. One of the reasons for the popularity of Reed-Muller codes has been its ability to correct errors in a code-word with relatively simple hardware.

Although error correction codes like Bose, Ray-Chaudhuri, Hocquenghem (BCH), and Reed-Solomon may offer a better error correction rate than Reed-Muller, an extremely efficient decoding scheme has been discovered for the first-order Reed-Muller code. Neither BCH nor Reed-Solomon codes have such a decoding scheme and, as a result, are not as efficient as Reed-Muller codes.

Another disadvantage of BCH and Reed-Solomon Codes is that neither coding scheme allows for progressive correction. Progressive correction is the process in which a previously encoded code-word may be available before the entire code-word is decoded. For example, leading edge NAND flash requires multiple bit error correction. The correction code-word length within NAND flash can be long (e.g. 528 bytes). With BCH or Reed-Solomon codes, each code-word must be entirely decoded before being further processed. As a result, data performance may be impaired (e.g., the quality of playback of a song by a Portable MP3 player may degrade).

### SUMMARY OF INVENTION

A method and apparatus for encoding and decoding Reed-Muller codes are provided. In exemplary embodiments, a method comprises receiving a code-word encoded with a Reed-Muller code, generating a pattern to retrieve voting bits, decoding the code-word based on the voting bits, and providing the decoded code-word.

In other exemplary embodiments, a system comprises an input data buffer, a XOR network for TX table, a pattern generator, and an output buffer. The input data buffer may be configured to receive a code-word encoded with a Reed-Muller code. The XOR network for TX table may be configured to receive the code-word and decode the code-word based on voting bits. The pattern generator is configured to generate a pattern to retrieve the voting bits. The output buffer may be configured to provide the decoded code-word.

Further, a computer readable medium may have embodied thereon instructions executable by a processor. The instructions may correspond to a method comprising receiving a code-word encoded with a Reed-Muller code, generating a pattern to retrieve voting, bits decoding the code-word based on the voting bits, and providing the decoded code-word.

### BRIEF DESCRIPTION OF THE DRAWINGS

FIG. 1 is a block diagram depicting the encoding of a code-word in an exemplary embodiment.

FIG. 2 is a block diagram depicting the decoding of a code-word in an exemplary embodiment.

FIG. 3 is a block diagram for output of temporary data during the encoding process in exemplary embodiments.

FIG. 4 depicts a circuit diagram for encoding a Reed-Muller code in an exemplary embodiment.

FIG. 5 depicts a block diagram of an implementation for output of temporary data during encoding process in exemplary embodiments.

FIG. 6 is a block diagram depicts a coder for decoding data in another exemplary embodiment.

FIG. 7 is a block diagram depicting pattern generation for decoding a code-word in an exemplary embodiment.

FIG. 8 depicts a pattern generator 706 in an exemplary embodiment.

FIG. 9 is a block diagram depicting a system for decoding and recovering one order of message bits in an exemplary embodiment.

### DETAILED DESCRIPTION OF EXEMPLARY EMBODIMENTS

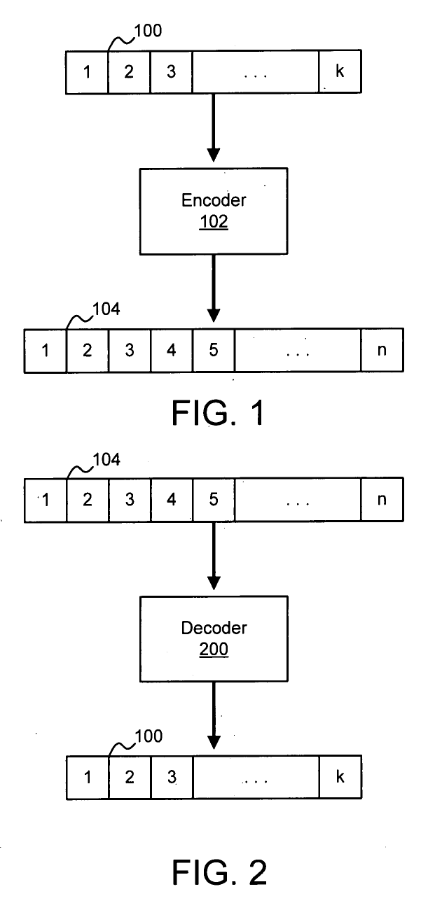

FIG. 1 is a block diagram depicting the encoding of a code-word in an exemplary embodiment. An encoder 102 receives “k” input bits 100 (i.e., the data to be encoded) and outputs “n” bits 104 (i.e., the encoded code-word). The number of output bits 104 is more than the number of input bits 102 (i.e., n>k).

FIG. 2 is a block diagram depicting the decoding of a code-word in an exemplary embodiment. A decoder 200 can do the inverse of the encoder 102 wherein the decoder 200 decodes the output “n” bits 104 received from the encoder 102 and outputs the original “k” input bits 100.

In one example, let the notation of RM(r,m) be used to represent Reed-Muller code of order “r” and length n=2^{m}. Let m̅ be the input message vector of “k” bits, “ G̅ ” be the code-word generating matrix, and “ c̅” be the code-word generated at the output. As used herein, terms with a line (or bar) above are vectors. The relationship is expressed in equation 1.

c̅= m̅G̅ (1)

Each of the vectors can be partitioned as vectors of a lower order. For example, for an RM(2,4) code, the vectors are as follows:

$$\begin{matrix}\overline{c} = ( c 0 , c 1 , c 2 , … c 15 ) & ( 2 ) \\ \overline{c} = \overline{c} 0 ⊕ \overline{c} 1 ⊕ \overline{c} 2 ( wherein ⊕ represents an XOR function ) & ( 3 ) \\ \overline{m} = [ \overline{m} 0 \vert \overline{m} 1 \vert \overline{m} 2 ] & ( 4 ) \\ \overline{G} = [ \begin{matrix}\overline{G} 0 \\ \overline{G} 1 \\ \overline{G} 2\end{matrix} ] & ( 5 ) \\ \overline{G} = [ \begin{matrix}1111111111111111 \\ 0000000011111111 \\ 0000111100001111 \\ 0011001100110011 \\ 0101010101010101 \\ 0000000000001111 \\ 0000000000110011 \\ 0000000001010101 \\ 0000001100000011 \\ 0000010100000101 \\ 0001000100010001\end{matrix} ] & ( 6 )\end{matrix}$$

Note that in this case, the number of encoded bits is (n=16) and number of input bits to the encoder is (k=11).

Although many examples discuss RM (2,4), those skilled in the art will appreciate that exemplary embodiments discussed herein may be effective with a Reed-Muller implementation of any order and/or any length. Further, although Reed-Muller codes are discussed, it will be appreciated that various embodiments herein may be effective with other coding approaches.

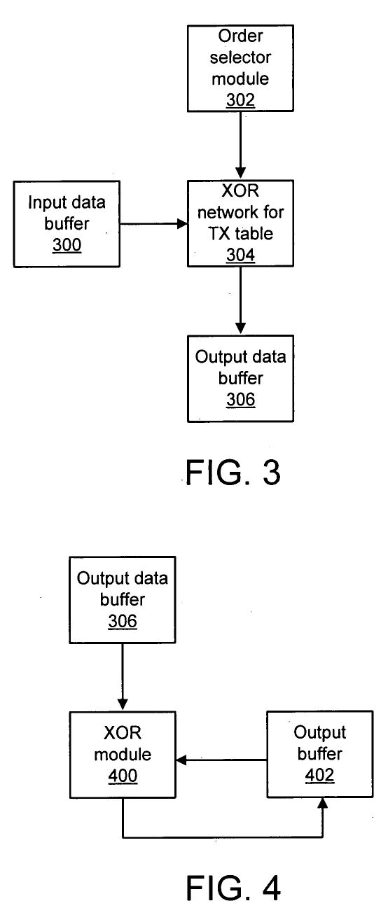

FIG. 3 is a block diagram depicting the output of temporary data during the encoding process in exemplary embodiments. The encoder 102 may comprise an input data buffer 300, an order selector module 302, an XOR network for TX table 304, and an output data buffer 306. Note that, in exemplary embodiments, the diagram in FIG. 3 is also applicable to the processing of a block of a decoded code-word in the preparation of a block of data for the next progressive decoding.

An input data buffer 300 can hold data ( m̅) to be encoded. The circuit XOR network for TX table 304 can implement m̅G̅ (see equations 5 and 6) based on an order selection signal that may select to combine elements of m̅ to elements of G̅ and/or that may select between the three circuits ( G̅0, G̅1, and G̅2). The order selector module 302 can generate the order selection signal. In the example in equation 6, G̅0 is represented as the row of “1”s, G̅1 is represented as the next four rows, and G̅2 is represented as the next six rows.

Although the XOR network for TX table 304 may be implemented as a circuit and/or a table, the XOR network for TX table 304 may also be implemented in software, within a solid state machine, programmable chip, or a combination of hardware and software. In some embodiments, the XOR network for TX table 304 may be operated with a table and/or any data structure such as an array.

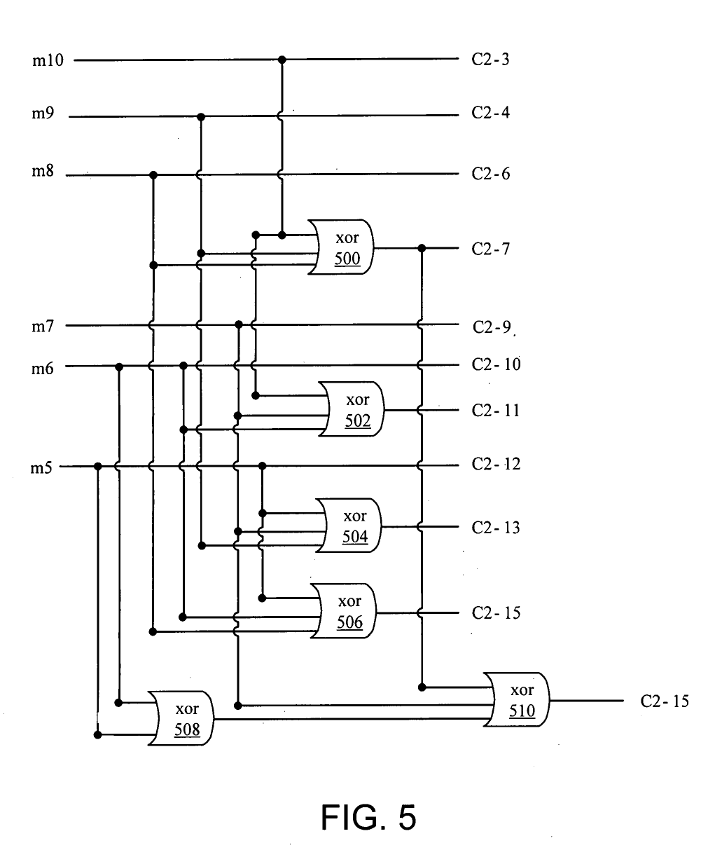

In one example, the input data buffer 300 provides bits of m̅ (e.g., m5, m6, m7, m8, m9, m10) to be encoded to the XOR network for TX table 304. The XOR network for TX table 304 multiplies each bit with the appropriate element(s) of G̅. The selector signal from the order selection module 302 determines which element(s) of G̅ to combine with the bits of m̅ to create the elements of c which are stored in the output data buffer 306. In one example, the circuit for G1 is a four input, sixteen output circuit which is implemented using a 4-bit counter to successively generate the coefficients to be “AND” with the message bits, generating c1. In another example, the circuit may be described as an XOR network as depicted in FIG. 5 (further discussed herein). Other ways of implementation may include the use of a table storing the elements of the matrix G̅.

The output data buffer 306 can hold the temporary data c̅0, c̅1, or c̅2 received from the XOR network for TX table 304. To complete the encoding process, a circuit that implements equation 3 may be used within FIG. 4.

FIG. 4 is a block diagram depicting a system for further encoding data in an exemplary embodiment. As described previously, the output data buffer 306 receives the temporary data. These elements may be added (e.g., via the XOR module 400).

FIG. 5 is a block diagram depicting the output of encoded data in exemplary embodiments. In one example, the circuit can combine message bits (e.g., m5-m10) with G̅2 to produce c̅2.

The terms c̅0, c̅1, and c̅2 may then combine via XOR (see equation 3) using the circuit depicted in FIG. 4. The encoded code-word may be output to the output buffer 402 and/or transmitted. A receiver (not depicted) may receive the transmitted information as r̅. If there are no errors in transmission, then c̅= r̅.

The XOR network for TX table 304 may serially multiply elements of m̅ with G̅0, G̅1, and G̅2, respectively. In other embodiments, the process is completed approximately simultaneously and/or in parallel.

Those skilled in the art will appreciate that the circuits and/or functions depicted in FIGS. 3-5, may be used for encoding as well as decoding. For example, the output buffer 306 may receive and hold decoded bits which can be redirected back to the XOR module 400 to help decode lower order bits (which is further described herein).

In one example, FIG. 3 may depict part of the process residing in decoder 200 wherein the input data buffer 300 provides \hat{m} (wherein \hat{m} is the estimate of an associated code-word m̅) to the XOR network for TX table 304. In one example, the order selector module 302 generates a selector signal which is provided to the XOR network for TX table 304 which may then be used to generate elements of ĉ.

To decode the encoded data, the highest order bits (\hat{m}2 in our example wherein the hat represents the recovered decoded bits) can be decoded first. Upon recovering the highest order bits, the recovered values may be used to generate corresponding encoded data, which will be used to remove influence from the remaining bits. This procedure may progress until the last message bits have been recovered.

In various embodiments, by examining the Reed-Muller codes designed from a geometric point of view, the sets of orthogonal check sums used in computing the message bit estimates exhibit a pattern with respect to bit-locations. These patterns can be generalized into a function which allows an efficient implementation. In exemplary embodiments, this function is described in FIG. 7 as a pattern generator 706 further described herein.

Once the bits r̅ is recovered, the elements of the bits of r̅ are combined in the pattern to generate votes for elements of the decoded message \hat{m} wherein, for example, \hat{m}=[\hat{m}0|\hat{m}1|\hat{m}2] and, for example, \hat{m}2=(\tilde{m}5,\tilde{m}6,\tilde{m}7,\tilde{m}8,\tilde{m}9,\tilde{m}10). In one example, patterns of the elements of r̅ are added together to create votes for each term of \hat{m}x (e.g., \tilde{m}5). The votes are used to determine the value of each term of \hat{m} thereby decoding the message.

In one example of decoding the encoded data, the highest order bits are decoded first; let r̅ be the received coded bits and \hat{m} be the recovered decoded bits.

\hat{m}=[\hat{m}0|\hat{m}1|\hat{m}2] (7)

The highest order bits can be recovered (\hat{m}2) using the received coded bits r̅. Then the influence of \hat{m}2 can be removed from the received coded bits. In one example, the removal of the influence of \hat{m}2 is a binary arithmetic equation including the negation in equation 8 (see below) which can be implemented as an XOR operation.

r̅′= r̅−\hat{m}2 G̅2 (8)

The next highest order bits can proceed to be recovered (\hat{m}1) using the updated coded bits r̅′. The influence of \hat{m}1 will be removed from the received coded bits.

r̅″= r̅′−\hat{m}1 G̅1 (9)

This procedure can repeat until the coded bits vector holds only the zero order bits, and in our example, the last coded bits vector is r̅″.

r̅″=\hat{m}0I+ε (10)

“I” is a unity vector that contains all ones and ε is the error vector. Recall that if there is no error then r̅″ is the \hat{m}0 value repeated n times (n votes).

With the data for the second term of the equation being placed in a buffer (i.e., equation 8) and similarly for operations for each of the other orders it can be implemented by a single circuit (e.g., FIG. 4) wherein versions of the coded bits r̅ are retained in the output data buffer 306 and the output buffer 402 before the XOR module 400 performs the negation operation.

In one example, the decoder 200 comprises the output data buffer 306, the XOR module 400, and the output buffer 402 depicted in FIG. 4. The output data buffer 306 receives the highest order bits and provides them to the XOR module 400 which outputs the estimated highest order bits r̅′ to the output buffer 402.

The circuit represented in FIG. 5 is a block diagram of an implementation for output of temporary data during encoding process in exemplary embodiments. In various embodiments, FIG. 5 is an example for the implementation of the second term in equation 8. The circuit can determine the r̅ terms by applying the XOR function (e.g., via XOR 500 from right to left) with the \hat{m}x G̅x term. The results are provided to the output data buffer 306 referenced above in FIG. 4.

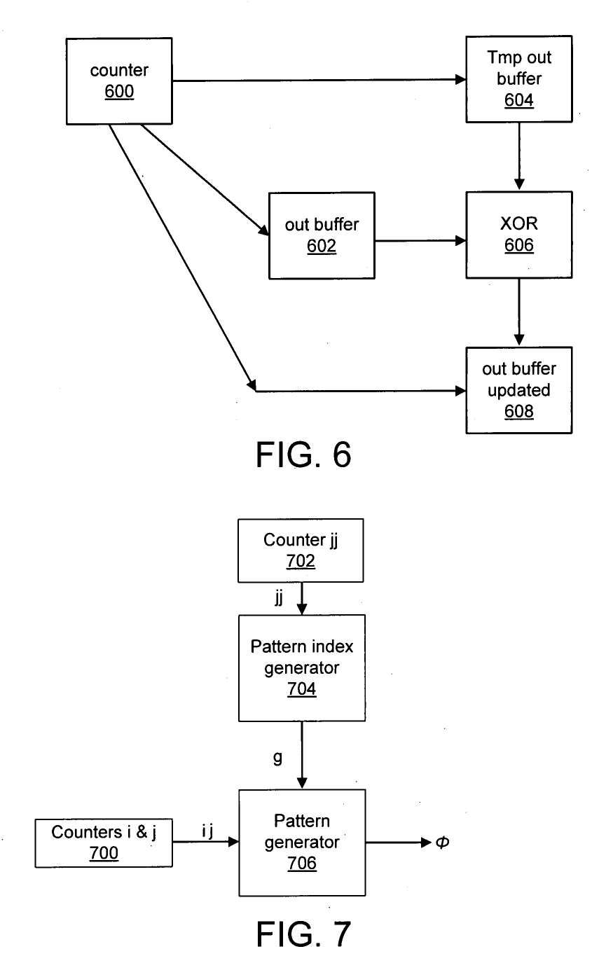

FIG. 6 is a block diagram depicting a coder for decoding data in another exemplary embodiment. A counter 600 can provide a counter and/or the selector signal to an out buffer 602, a TMP out buffer 604, and an out buffer updated 608. The temporary decoded r̅ elements (e.g., r̅′) may be buffered in the TMP out buffer 604. The out buffer 602 may provide an \hat{m}x G̅x element. Based on the counter, the proper temporary decoded r̅ element is subtracted (XOR) from the proper \hat{m}x G̅x element within the XOR 606. The output is placed in out buffer updated 608

The value that has the most occurrences in r̅″ would be taken as the recovered \hat{m}0. This voting scheme also applies the other message bits. In one example, for \hat{m}1, each of the bits to be recovered has 8 votes. Each of the votes is obtained from a different combination of the received coded bits. Similarly, for \hat{m}2 each of the bits to be recovered have 4 votes. The number of votes per bit varies for different RM code. For the example we have used so far it is RM(2,4).

$$\begin{matrix}\hat{m} 2 = ( \tilde{m} 5 , \tilde{m} 6 , \tilde{m} 7 , \tilde{m} 8 , \tilde{m} 9 , \tilde{m} 10 ) & ( 11 ) \\ \{ \begin{matrix}\tilde{m} {10}^{( 1 )} = r 0 + r 1 + r 2 + r 3 \\ \tilde{m} {10}^{( 2 )} = r 4 + r 5 + r 6 + r 7 \\ \tilde{m} {10}^{( 3 )} = r 8 + r 9 + r 10 + r 11 \\ \tilde{m} {10}^{( 4 )} = r 12 + r 13 + r 14 + r 15\end{matrix} \} & ( 12 ) \\ \{ \begin{matrix}\tilde{m} {9}^{( 1 )} = r 0 + r 1 + r 4 + r 5 \\ \tilde{m} {9}^{( 2 )} = r 2 + r 3 + r 6 + r 7 \\ \tilde{m} {9}^{( 3 )} = r 8 + r 9 + r 12 + r 13 \\ \tilde{m} {9}^{( 4 )} = r 10 + r 11 + r 14 + r 15\end{matrix} \} & ( 13 ) \\ \{ \begin{matrix}\tilde{m} {8}^{( 1 )} = r 0 + r 1 + r 8 + r 9 \\ \tilde{m} {8}^{( 2 )} = r 2 + r 3 + r 10 + r 11 \\ \tilde{m} {8}^{( 3 )} = r 4 + r 5 + r 12 + r 13 \\ \tilde{m} {8}^{( 4 )} = r 6 + r 7 + r 14 + r 15\end{matrix} \} & ( 14 ) \\ \{ \begin{matrix}\tilde{m} {7}^{( 1 )} = r 0 + r 2 + r 4 + r 6 \\ \tilde{m} {7}^{( 2 )} = r 1 + r 3 + r 5 + r 7 \\ \tilde{m} {7}^{( 3 )} = r 8 + r 10 + r 12 + r 14 \\ \tilde{m} {7}^{( 4 )} = r 9 + r 11 + r 13 + r 15\end{matrix} \} & ( 15 ) \\ \{ \begin{matrix}\tilde{m} {6}^{( 1 )} = r 0 + r 2 + r 8 + r 10 \\ \tilde{m} {6}^{( 2 )} = r 1 + r 3 + r 9 + r 11 \\ \tilde{m} {6}^{( 3 )} = r 4 + r 6 + r 12 + r 14 \\ \tilde{m} {6}^{( 4 )} = r 5 + r 7 + r 13 + r 15\end{matrix} \} & ( 16 ) \\ \{ \begin{matrix}\tilde{m} {5}^{( 1 )} = r 0 + r 4 + r 8 + r 12 \\ \tilde{m} {5}^{( 2 )} = r 1 + r 5 + r 9 + r 13 \\ \tilde{m} {5}^{( 3 )} = r 2 + r 6 + r 10 + r 14 \\ \tilde{m} {5}^{( 4 )} = r 3 + r 7 + r 11 + r 15\end{matrix} \} & ( 17 )\end{matrix}$$

The estimation on each of the decoded bits is obtained by XOR of a particular combination of coded bits together. Each set of points that are to be XOR together forms a vector in the m-dimensional Euclidean geometry space. By translating the vector within the same geometry space, a new vector is found with its set of coordinate points being the bits that are to be XOR together to form the next estimation. In our example, \tilde{m}5 was found to have four translations of the vector (wherein the term with a tilde may represent an approximation based on the votes).

The particular combination of coded bits is a pattern that may be generated in real-time or stored as tables. The implementations might be by software, created in firmware, hardware, or any combination. In various embodiments, the pattern is generated. In one example, the pattern may be generated for each element of \hat{m} (e.g., \hat{m}0, \hat{m}1, \hat{m}2 or elements thereof).

These patterns may be generated in parallel, series, or any combination thereof. In one example, the generation of the pattern may reduce the number of gates necessary and the complexity of a circuit if higher order Reed-Muller codes were decoded strictly by hardware without pattern generation. Further, in another example, the generation of the pattern may eliminate or reduce a decoding table.

If there are points missing or the received coded data has been punctured on purpose, the translated vectors may not be affected (e.g., if the missing points are not part of the translated vector). For example, if the bit r15 has been punctured away, then, in some embodiments, estimations that require r15 may not be used. Each of the estimations in equation 11 would only have 3 votes. Thus, it is concluded that a RM code can be punctured by throwing away the use of an arbitrary number of bits located at any location as long as the retained coded bits can contribute enough to meet the number of votes required. Note that in order to correct “t” number of bit errors, the number of votes can be at least 2*t+1 so that there is enough correct bits to win the majority vote.

It is tedious to calculate the choice of points needed to obtain each of the votes. In some embodiments, to reduce the computation intensity of the decoder design, points may be stored in a memory device such as a hard drive, random access memory, and/or read-only memory.

However, in other embodiments, there is no need to store each of the code points. It is observed that the sequence of points to decode code-words can form a pattern. Patterns for recovering a message can be generalized into a single equation.

FIG. 7 is a block diagram depicting pattern generation for decoding a code-word in an exemplary embodiment. A single equation can be implemented efficiently and used within pattern generator 706 to generate vectors to decode code-words. A pattern index, generated by the pattern index generator 704, can be used to select which pattern is to be generated.

In one example, counter jj 702 provides jj to the pattern index generator 704. The pattern index generator 704 provides a pattern index (g) to the pattern generator 706. The counter i and counter j 700 provide counters (i and j, respectively) to the pattern generator 706 which generates the pattern (e.g., vector) φ for decoding code-words.

In various embodiments, the pattern index value associated with the corresponding message bit can be stored in a memory device or generated by logic gates. The complexity of the implementation may be less than storing all the code points needed for estimation each of the message bits. For example, equation 12 can be represented as:

$$\begin{matrix}\tilde{m} {10}^{( i )} = {\sum }_{i = 0}^{3} {r}_{φ i j} & ( 18 ) \\ φ i j = j + 4 i & ( 19 )\end{matrix}$$

All the message bits that are to be estimated in equation 11 uses the equation 18 with the label changed. Thus, equation 12-17 may differ in the bit indexing of the received bits. The index equations for equation 12-17 are as follows:

From equation 12,

φij=j+4i (20)

From equation 13,

φij=j+(j/2)4+i2+(i/2)4 (21)

From equation 14,

φij=j+(j/2)6+i2 (22)

From equation 15,

φij=j2+i+(i/2)6 (23)

From equation 16,

φij=j2+(j/2)4+i+(i/2)2 (24)

From equation 17,

φij=j4+i (25)

Note that equations 20-25 may be implemented in fixed-point integer arithmetic. Equations 20-25 can be unified into one equation shown below:

φij=j2^{b}^{₀}+(j/2)2²b₁+(j/2)2b₂+i2^{b}^{₃}+(i/2)2b₄+(i/2)b₅ (26)

b₀=0,1,2

b₁=0,1

b₂=0,1

b₃=0,1,2

b₄=0,1,2

b₅=0,1 (27)

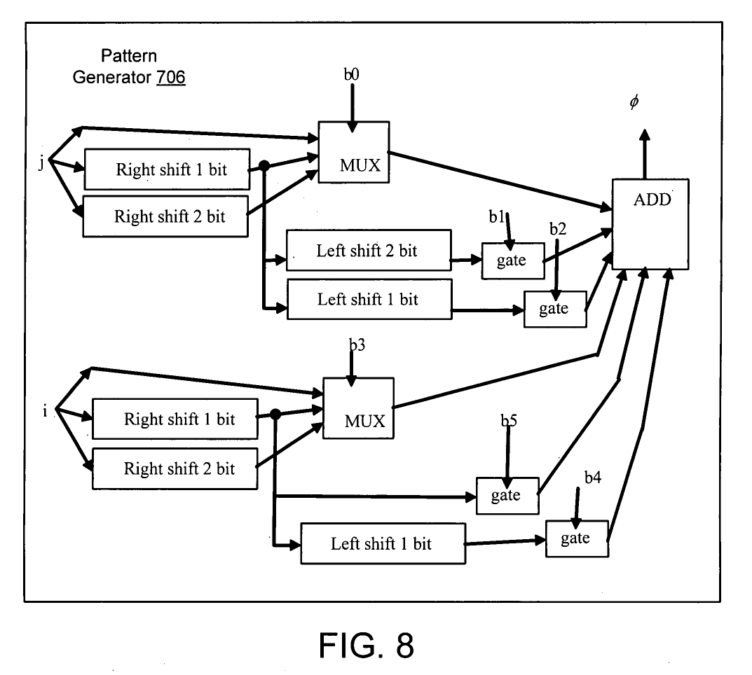

Equation 26 can be implemented using binary shifters and adders as depicted in FIG. 8. FIG. 8 depicts a pattern generator 706 in an exemplary embodiment. Those skilled in the art will appreciate that the pattern generator 706 can generate the pattern needed to decode many orders of Reed-Muller codes.

The pattern generator 706 receives a pattern index (e.g., the bₓ terms) from the pattern index generator 704 to set the generator to a particular pattern. One example of the pattern index comprises the control bits in equation 27.

The pattern index, for the example RM(2,4) code, showing implementation of order 2 only is as follows:

| | b0b1b2b3b4b5 |
|---|---|
| \tilde{m}10 | 000200 |
| \tilde{m}9 | 010120 |
| \tilde{m}8 | 011100 |
| \tilde{m}7 | 100021 |
| \tilde{m}6 | 110010 |
| \tilde{m}5 | 200000 |

The pattern index generator 704 can output the pattern index upon receiving the location of the decoding message bit, number 5 to 10 in our example. Conceptual implementation of the pattern generator 706 and the pattern index generator 704 is shown in FIG. 7. The input “jj” is the decoding message bit location, for example a value 5-10; “j” is the input iterating from 0 to the number of points per vote, for example the “j” index in equation 26, the “i” is the input iterating from 0 to number of votes, for example the “i” index in equation 26 and “g” is the “pattern index”, for example the values in the table above. The output “φ” can be used as an address to a buffer that holds the received bits to be decoded.

Those skilled in the art will appreciate that the implementation of the pattern index generator 704 may be performed in many ways. In two examples, the implementation of the pattern index generator 704 may be performed using memory devices or by direct circuit implementation.

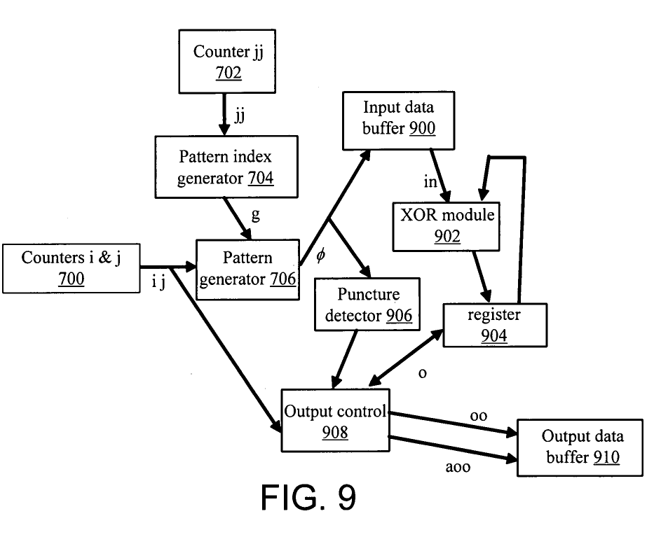

FIG. 9 is a block diagram depicting a system for decoding and recovering message bits in an exemplary embodiment. Counters i and j 700 provide counters “i” and “j” to the pattern generator 706 and the output control 908. Counter jj 702 provides counter “jj” to the pattern index generator 704 which then, based on the counter “jj”, provides pattern generation control signals to the pattern generator 706. The pattern generator 706 generates the pattern based on the pattern generation control signals and provides the pattern to the input data buffer 900 and the puncture detector module 906.

The output control 908 receives counters “i” and “j” from the counters i & j 700, respectively, as well as puncture information from the puncture detector module 906. The output control 908 also increments the internal voting count according to the result from register 904 if the (“i”, “j”) combination is not a puncturing point, and if the (i,j) is a puncturing point, the value in register 904 may be reset to zero. Upon finishing the vote for one message bit, the result may be sent to an output data buffer 910.

In our example above, the message is composed of three code orders (recall from equation (7)). The entire circuit shown in FIG. 9 may be run twice to retrieve \hat{m}2 and \hat{m}1. For \hat{m}0, the pattern generator may not be needed and only part of the circuit in FIG. 9 is used.

In an example with RM(2,4), the received coded bits ( r̅) is first loaded into the input data buffer 900. The counter “j” can be reset to start counting from 0 and can modulo back to 0 after a maximum value 3 is reached. The counter “i” can be reset to start counting from 0 and will modulo back to 0 after a maximum value 3 is reached. Whenever counter “j” has looped back to 0, counter “i” can be incremented by 1. Counter jj can be set to count down from 10. The pattern generator 706 can generate the address to the received coded bits sequentially. The output “φ” can have values: “0, 1, 2, 3, 4, 5, . . . ”. The single-bit register 904 can be reset to 0 before the first XOR module 902 operation. The bit fetched from the input data buffer 900 can be XOR'ed (e.g., by the XOR module 902) with the accumulated bit inside the register 904 and stored back in the register 904 to prepare for the next bit to come. The output control 908 can retrieve the value from the register 904 when one estimate of the message bit is done (i.e., counter “j” has reached its maximum value).

The register 904 can be reset back to 0 after the value has been read by the output control 908. The output control 908 may have a counter internally to count the number of 1 observed from reading the register 904. When the count value “i” has reached its maximum, the circuit inside output control 908 may decide whether the majority vote for the current message bit estimation is a 1 or 0 based on the internal counter. The decision (“oo”) may be placed in the output data buffer 910 with address (“aoo”). The address is generated based on the count value “i”. When the count value “jj” has reached the last index for the order, the output data buffer 910 can hold the estimated message bits, for example (\hat{m}2).

To continue the decoding process, the content of output data buffer 910 can be transferred to the input data buffer 300 in FIG. 3 and proceed to perform the multiplication term in equation 8, (\hat{m}2 G̅2). That is, the circuit used in the encoder can be reused here in the decoder. And to finish the arithmetic in equation 8, the circuit depicted in FIG. 4 can be reused. The result is copied back into input data buffer 900 of FIG. 9 and then proceeds to decode the next order message bits.

The puncture detection module 906 can monitor the location of the received bits “φ” to be used. If “φ” is addressing a punctured point, then the puncture detection module 906 can send a puncture signal to the output control 908. Upon receiving the puncture signal, the output control 908 can discard the current message bit vote and adjust the count for majority.

The above-described functions and components, including but not limited to functions, can be comprised of instructions that are stored on a storage medium (e.g., hard drive, flash memory, RAM, ROM, PIC chip, and a programmable chip). The storage medium may be computer readable. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

Further, although FIGS. 1-9 depict various examples, these figures are exemplary. Alternative embodiments may comprise more components, less components, or equivalent components and still be within the scope of embodiments of the present invention.

Embodiments of the present invention have been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method comprising:
receiving a code-word encoded with a Reed-Muller code;
generating a pattern to retrieve voting bits;
decoding the code-word based on the voting bits; and
providing the decoded code-word.

2. The method of claim 1, wherein the Reed-Muller code comprises a Reed-Muller code with an order greater than 1.

3. The method of claim 1, further comprising generating a pattern control signal based on a counter.

4. The method of claim 3, wherein generating the pattern to decode the code-word is also based on the pattern control signal.

5. The method of claim 1, further comprising combining the voting bits based on the generated pattern to generate votes and comparing the votes to estimate a decoded code-word value.

6. The method of claim 1, further comprising determining a puncture.

7. The method of claim 6, further comprising disregarding the voting bits associated with the puncture, combining the voting bits based on the generated pattern to generate votes, and eliminating votes that are associated with punctured bits.

8. The method of claim 1, wherein decoding the code-word comprises determining a highest order bit and removing an influence of the higher order bit to determine a lower order bit.

9. The method of claim 8, wherein logic configured to decode the code-word is reusable in an encoder.

10. A system comprising:
an input data buffer configured to receive a code-word encoded with a Reed-Muller code;
a XOR network for TX table configured to receive the code-word and decode the code-word based on voting bits;
a pattern generator configured to generate a pattern to retrieve the voting bits; and
an output buffer configured to provide the decoded code-word.

11. The system of claim 10, wherein the Reed-Muller code comprises a Reed-Muller code with an order greater than 1.

12. The system of claim 10, further comprising a pattern index generator configured to generate a pattern control signal based on a counter.

13. The system of claim 12, wherein the pattern generator is further configured to generate the pattern to decode the code-word based on the pattern control signal.

14. The system of claim 10, further comprising an XOR module configured to combine the voting bits based on the generated pattern to generate votes and an output control configured to compare the votes to estimate a decoded code-word value.

15. The system of claim 10, further comprising a puncture detector configured to determine a puncture.

16. The system of claim 15, further comprising an output control configured to disregard the voting bits associated with the puncture, combine the voting bits based on the generated pattern to generate votes, and eliminate votes that are associated with punctured bits.

17. The system of claim 10, wherein the XOR network for TX table configured to decode the code-word comprises an output control configured to determine a highest order bit and removing an influence of the higher order bit to determine a lower order bit.

18. The system of claim 17, wherein logic configured to decode the code-word is reusable in an encoder.

19. A computer readable medium having embodied thereon instructions executable by a processor, the instructions corresponding to a method comprising:
receiving a code-word encoded with a Reed-Muller code;
generating a pattern to retrieve voting bits;
decoding the code-word based on the voting bits; and
providing the decoded code-word.

20. The computer readable medium of claim 19, wherein the Reed-Muller code comprises a Reed-Muller code with an order greater than 1.

21. The computer readable medium of claim 19, wherein the method further comprises generating a pattern control signal based on a counter.

22. The computer readable medium of claim 21, wherein the method further comprises generating the pattern to decode the code-word is also based on the pattern control signal.

23. The computer readable medium of claim 19, wherein the method further comprises combining the voting bits based on the generated pattern to generate votes and comparing the votes to estimate a decoded code-word value.

24. The computer readable medium of claim 19, wherein the method further comprises determining a puncture.

25. The computer readable medium of claim 23, wherein the method further comprises disregarding the voting bits associated with the puncture, combining the voting bits based on the generated pattern to generate votes, and eliminating votes that are associated with punctured bits.

26. The computer readable medium of claim 19, wherein decoding the code-word comprises determining a highest order bit and removing an influence of the higher order bit to determine a lower order bit.

27. The method of claim 26, wherein logic configured to decode the code-word is reusable in an encoder.
